(19) United States
(12) Patent Application Publication
(10) Pub. No.: US 2003/0025721 A1
(43) Pub. Date: Feb. 6, 2003

(54) Hand mounted ultrasonic position determining device and system

(76) Inventors: Joshua Clapper, Bryn Mawr, PA (US); Minoru Toda, Lawrenceville, NJ (US); Kyung-Tae Park, Berwyn, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/026,287

(22) Filed: Mar. 4, 2002

Related U.S. Application Data
(60) Provisional application No. 60/310,283, filed on Aug. 6, 2001.

(51) Int. Cl. G09G 5/00

(52) U.S. Cl. 345/700; 345/156

(57) ABSTRACT

A system for determining and indicating the position of a finger removes the requirement for a conventional keyboard when providing information to a processor. Various embodiments of the present invention include combinations of ultrasonic, electromagnetic, and optical transducers and devices mounted on various locations of a user's hands and fingers. A character grid, or template, is also included to allow a user to select characters on the grid. The location of a particular finger is used to determine which keyboard character and/or control character on the character grid is being selected. A pair of glove like devices mounted on a user's hands have transducers mounted on the fingers. These transducers include piezoelectric film ultrasonic transducers. The transducers may be mounted on the fingertips of the user, on around the finger like a ring. Because the position of each finger is determined by the system, the character grid is not required to supply this information to the processor. Thus, the character grid may be made of any material capable of visually depicting keyboard type characters, such as plastic or paper. This character grid may be rolled or folded when not in use.

This application claims the benefit of U.S. provisional patent No. 60/310,283, filed on Aug. 6, 2001, which is herein incorporated in its entirety.

### FIELD OF THE INVENTION

The present invention is generally related to electronics, and more specifically related to hand held input devices for computers.

### BACKGROUND

A continuing trend in the field of computer processing is the downsizing of computers and related equipment. This trend is observable in many of today's personal computers, laptop computers, notebook computers, and personal digital assistants (PDAs). One of the limiting factors in downsizing computers, is the size of the keyboard. Conventional keyboards are required to be large enough to house appropriate circuitry, and the keypads must be large enough to be ergonomically compatible with a user. Furthermore, many conventional keyboards utilize mechanical structures, such as on/off switches and keys for providing tactile feedback. These requirements and structures, among others, often result in keyboards that are large, bulky, and heavy. An apparatus for providing information to a processing system, which does not suffer the above disadvantages is desired.

### SUMMARY OF THE INVENTION

A device for indicating a position of a finger includes a piezoelectric film for providing a signal in accordance with a displacement of the film. The device is conformably shaped to fit on at least a portion of the finger. The signal is indicative of a position of the finger.

According to another aspect of the invention, an apparatus for indicating the position of at least one finger of a hand on which the apparatus is adapted to be mounted includes at least one transmitter for providing a position signal. The position signal is indicative of the position of a finger on which a transmitter is adapted to be mounted.

According to another aspect of the invention, a system for determining a position of at least one finger includes a transmitting portion for transmitting a respective ultrasonic signal indicative of a position of each finger of a hand on which the transmitting portion is adapted to be mounted. An ultrasonic transducer provides the respective ultrasonic signal. An ultrasonic transducer is shaped to be conformably positioned on each of the at least one finger. The system also includes a receiving portion for receiving the transmitted ultrasonic signals, and a processor for determining the position of each of the at least one finger in accordance with the received ultrasonic signals.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1 is a block diagram of an embodiment of a position determining system comprising a hand mounted transmitting portion;

FIG. 2 is a front view of an exemplary ultrasonic position determining system;

FIG. 3A is a back view of an exemplary digitizer glove;

FIG. 3B is a back view of an exemplary digitizer glove comprising ultrasonic transducers configured as rings;

FIG. 4 is a side view of a fingertip with pertinent portions identified;

FIG. 5 is a top view of system further showing a display device;

FIG. 6 is an illustration of another embodiment of the digitizer system comprising the receiving portion configured as a pod;.

FIG. 7 is an illustration of a system comprising the ultrasonic transducers positioned in a plane differing from and not parallel to the plane of the character grid;

FIG. 8 is an illustration of another embodiment of an ultrasonic transducer;

FIG. 9 is an illustration of an ultrasonic transducer mounted on a fingertip;

FIGS. 10A and 10B are two side views of an ultrasonic transducer depicting displacement of the ultrasonic transducer;

FIG. 11 is a graph of an exemplary voltage waveform resulting from the exemplary force exerted on transducer;

FIG. 12 is a graph of an exemplary force applied to a transducer mounted on a fingertip;

FIG. 13 is an illustration of another embodiment of an ultrasonic transducer positioned on a finger;

FIG. 14 is a circuit diagram of exemplary transmit/receive (T/R) circuitry;

FIG. 15 is a top view of a curved piezoelectric film;

FIG. 16 is an elevated view of a curved piezoelectric film;

FIG. 17 is an illustration of another embodiment illustrating a character grid comprising an electrode for sensing contact; and

FIG. 18 is an illustration of another embodiment, wherein the sensing signal is capacitively coupled to the receiving transducers through air.

### DETAILED DESCRIPTION

This description of the preferred embodiments is intended to be read in connection with the accompanying drawings, which are to be considered part of the entire written description of this invention. In the description, relative terms such as “front,” “back,” “lower,” “upper,” “horizontal,” “vertical,”, “up,” “down,” “top” and “bottom” as well as derivative thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Various examples described below comprise combinations of ultrasonic, electromagnetic, and optical transducers adapted to be mounted on various locations of a user's hand(s) and finger(s), and a character grid, for providing information related to the positions of individual fingers to a device and/or system, such as a computer processor, and/or a display device. The location of a particular finger is used to determine which keyboard character and/or control character on the character grid is being selected. Various examples described below include at least one glove-like device (preferably a pair of glove-like devices) mounted on a user's hand(s), transducers mounted on fingertips of a user, and transducer rings mounted on the fingers of a user. Furthermore, various embodiments of the present invention may function as a keyboard; a pointing device, such as a mouse and/or trackball; and/or a touch screen.

The examples described below comprise combinations of ultrasonic transducers, optical detectors/emitters (e.g., infrared), and electromagnetic transmitters/receivers (e.g., radio frequency antenna, electronic circuits). Ultrasonic transducing technology suitable for the exemplary embodiments is known in the art, an example of which is described in U.S. Pat. No. 6,239,535, issued to Toda et al., which is hereby incorporated by reference in its entirety. Also, the use of ultrasonic transducers to determine positional information is known in the art, an example of which is described in U.S. Pat. No. 6,163,253 issued to Yaron et al., which is hereby incorporated by reference in its entirety.

Ultrasonic transducers suitable for use in the exemplary embodiments may be formed with linear or curved film incorporated therein. An example is an ultrasonic transducer comprising Polyvinylidene Fluoride (PVDF), a polymer piezoelectric material, formed into a film. As is understood in the art, an alternating electrical potential applied to electrodes attached to the film causes the film to expand and shrink in response to the applied potential, thus emitting ultrasonic energy. Also, a deformation or displacement of the film creates an electrical potential having a polarity and amplitude in response to the deformation or displacement.

Optical detectors suitable for use in the exemplary embodiments may comprise any known optical device capable of receiving optical signals, such as photodiodes, phototransistors, and photodetectors, for example. Optical emitters suitable for use in the exemplary embodiments may comprise any known optical device capable of emitting optical signals, such as light emitting diodes (LEDs) and laser diodes, for example. Optical emitters and detectors may be operable on visible light, infrared, or both.

As described in more detail herein, electromagnetic transmitters and receivers suitable for use in the exemplary embodiments may comprise any appropriate device capable of transmission and reception of electromagnetic waves, such as radio frequency (RF) antenna, for example.

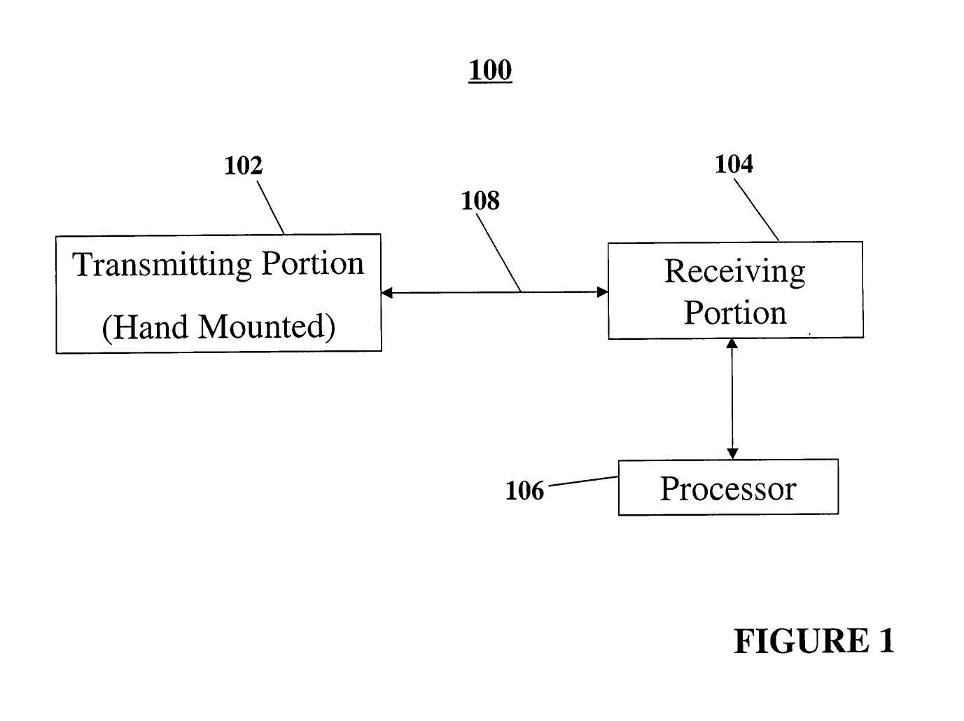

FIG. 1 is a block diagram of an embodiment of a position determining system 100 comprising a hand mounted transmitting portion 102. As described herein, system 100 is also referred to as a digitizing system. A digitizing system, as known in the art, is a system that converts the position of a point on a two-dimensional surface, or in three dimensions, into digital coordinate data. System 100 determines the position of at least one finger of a hand on which hand mounted transmitting portion 102 is mounted. Transmitting portion 102 comprises ultrasonic transducers, optical emitters, electromagnetic transmitters, or combinations thereof, for transmitting signals 108 to the receiving portion 104. Thus signals 108 may comprise various combinations of ultrasonic, optical, and electromagnetic signals. Receiving portion 104 comprises ultrasonic transducers, optical detectors, electromagnetic receivers, or combinations thereof for receiving signals 108.

Processor 106 is electrically coupled to receiving portion 104. Processor 106 processes the received signals to determine the position of each finger. Processor 106 may comprise a separate processing unit or circuit, or may be incorporated as part of a host processor, such as a personal computer, mainframe computer, lap top computer, notebook computer, PDA, or any combination thereof, for example. The processing (to determine the position of the ultrasonic transducers, and associated processing) may be accomplished by software residing on processor 106.

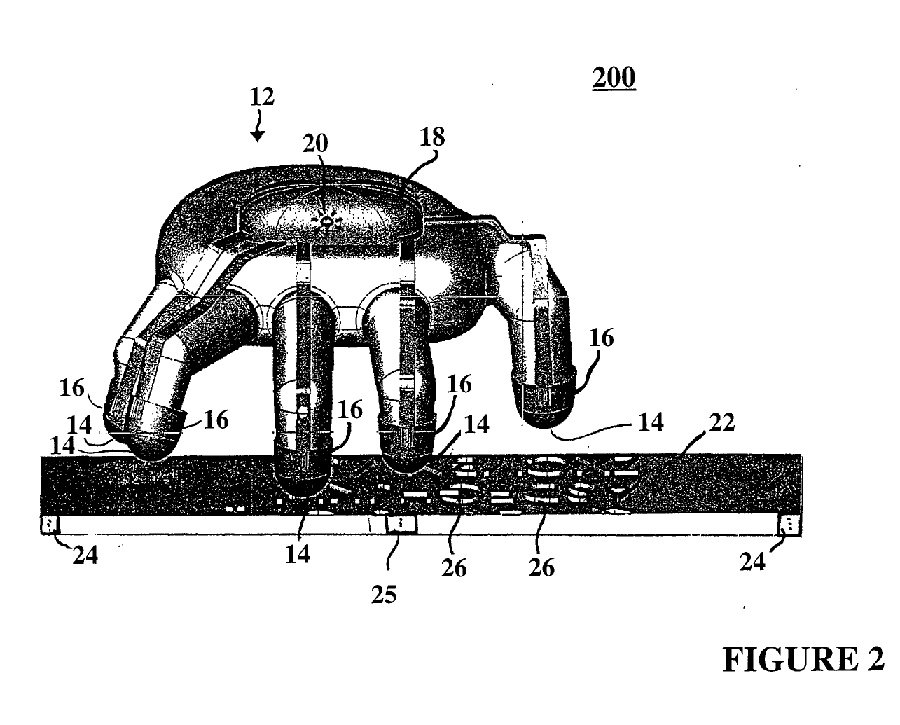

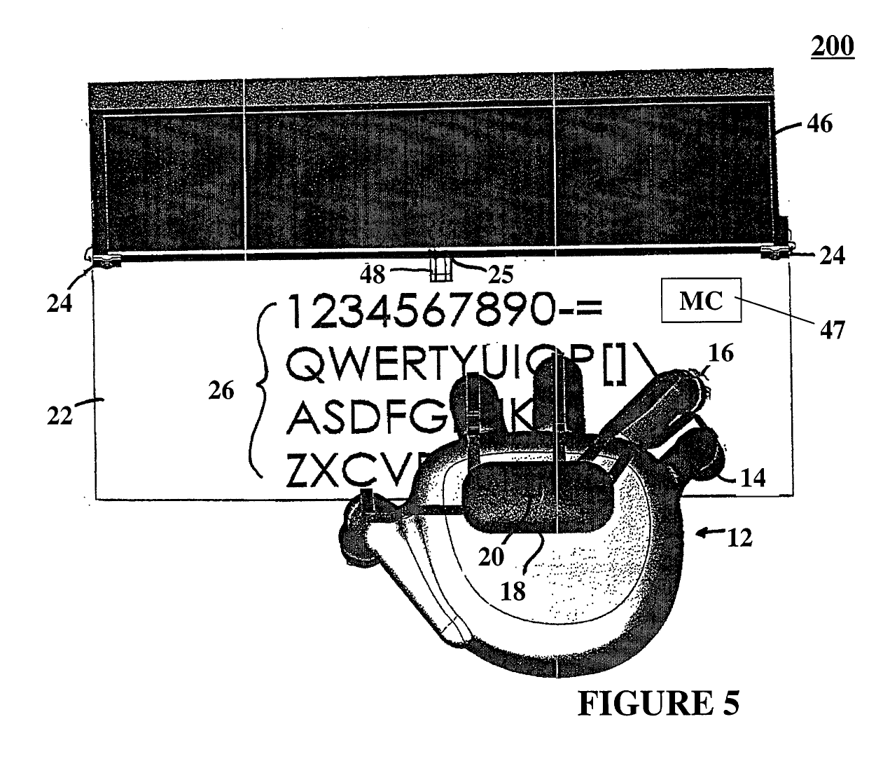

FIG. 2 is an illustration of an exemplary ultrasonic position determining system 200. Digitizing system 200 comprises a character grid 22, ultrasonic transducers 24, optical detector 25, and at least one digitizer glove 12. Right-hand digitizer glove 12 is shown in FIG. 2. Digitizer glove 12 comprises a switch 14 on each finger, a transducing device 16 on each finger, and a control device 18. Switches 14 may comprise any appropriate type of switch such as a pressure sensitive switch, a proximity switch, or any combination thereof. Examples of appropriate switches means include mechanical micro switches, membrane switches, resistive touch switches, piezoelectric film switches, accelerometers, vibration sensor switches, capacitive switches, and combinations thereof. In various embodiments described herein, switch 14 comprises a piezoelectric film for sensing the contact of the fingertip of digitizer glove 12 with the character grid 22. Transducing devices 16 may comprise any appropriate transducing device, such as an ultrasonic transducer. Control device 18 comprises a receiver/transmitter 20. Receiver/transmitter 20 may comprise an optical emitter (e.g., infrared, visible light, LED, laser diode), an optical detector (e.g., photodiode, photodetector, phototransistor), and/or an RF transmitter/receiver. In alternative exemplary embodiments, digitizer glove 12, character grid 22, or both, comprise a mode control switch for switching from keyboard mode to pointer mode (mode control switch not shown in FIG. 2, however a keyboard mounted mode control switch 47 is shown in FIG. 5).

Character grid 22, comprises alphanumeric and control characters 26 located at fixed positions, with respect to each other, on the surface of the grid 22. Characters 26 comprise visual representation of keyboard characters and any other application specific characters (e.g., mode control character to switch from keyboard mode to pointer mode). Character grid 22 may comprise any material capable of indicating characters 26, such as plastic, paper, and/or velum, for example. One advantage of a character grid 22 as described herein, is that it may be folded or rolled when not in use, thus reducing the size of the system 100. In another exemplary embodiment, character grid 22 comprises a pressure sensitive material, a piezoelectric film, variable resistance material, variable capacitance circuitry, or combination thereof for sensing the selection of a character on character grid 22.

System 200 comprises at least one ultrasonic transducer 24 for receiving or transmitting ultrasonic signals from or to the ultrasonic transducers 16 mounted on digitizing glove 12, and at least one optical device 25 (e.g., detector or emitter) for receiving or transmitting optical signals from or to the optical device 20 mounted on digitizer glove 12. In a preferred embodiment, digitizer glove 12 comprises an optical emitter 20 for transmitting optical signals to optical detector 25, and ultrasonic transducers 16 for transmitting ultrasonic signals to ultrasonic transducers 24. However, it is understood that the receiving and transmitting functions of the transducers and/or devices may be reversed in any combination (e.g., device 20 is an optical detector and transducers 16 are ultrasonic transmitters). For example, in an alternative embodiment, optical device 20 functions as an optical detector, optical device 25 functions as an optical emitter, ultrasonic transducers 16 function as ultrasonic receivers, and ultrasonic transducers 24 function as ultrasonic transmitters.

The optical emitter 20, which is mounted to the digitizing glove 12, transmits optical signals, which are received almost instantaneously (which is faster than transmission of ultrasonic signals) by the optical detector 25. The ultrasonic transducers 16 mounted to the digitizer glove 12 transmit acoustic signals, which are received, with a delay as compared to receipt of the optical signals, by ultrasonic transducers 24. Ultrasonic transducers 24 are positioned at fixed locations with respect to one another, having a specified separation therebetween. The position of a particular ultrasonic transducer 16 (fingertip) is determined by triangulation from the measured time of the received signals from each of the ultrasonic transducers 24. A more detail description of determining the position of ultrasonic transducers is disclosed in U.S. Pat. No. 4,814,552, which is hereby incorporated by reference in its entirety.

In one embodiment, the ultrasonic transducers 24 and optical detector 25 are positioned in fixed locations with respect to other components of the digitizer system 200 (e.g., character grid 22), such that propagation times may be calculated to determine the location of individual fingers of the digitizer glove(s) 12. One example of such an embodiment comprises receiving portion 104 (i.e., ultrasonic transducers 24 and optical detector 25) being fixedly attached to character grid 22. This configuration provides a relative fixed position of the characters on the character grid with respect to transducers/devices 24 and 25. Thus, allowing movement of the character grid without detrimentally affecting the position determining capability of the system 200.

In another embodiment, the relative locations of ultrasonic transducers 24 and optical detector 25 with respect to character grid 22 are not specified. Rather, the relative locations are determined during a calibration or registration phase prior to use. During a registration phase, predetermined registration characters on character grid 22 are selected, thus allowing the system to register the position of the registration character. A registration character may comprise any character or set of characters on character grid 22.

In a preferred embodiment, digitizer system 200 also comprises a left-hand digitizer glove configured to fit the left hand of a user (left-hand digitizer glove not shown in FIG. 2). The left-hand digitizer glove functions in the same manner as the right-hand digitizer glove 12 as described herein. All descriptions of embodiments included herein with respect to the right hand digitizer glove 12 can also pertain to the left hand digitizer glove.

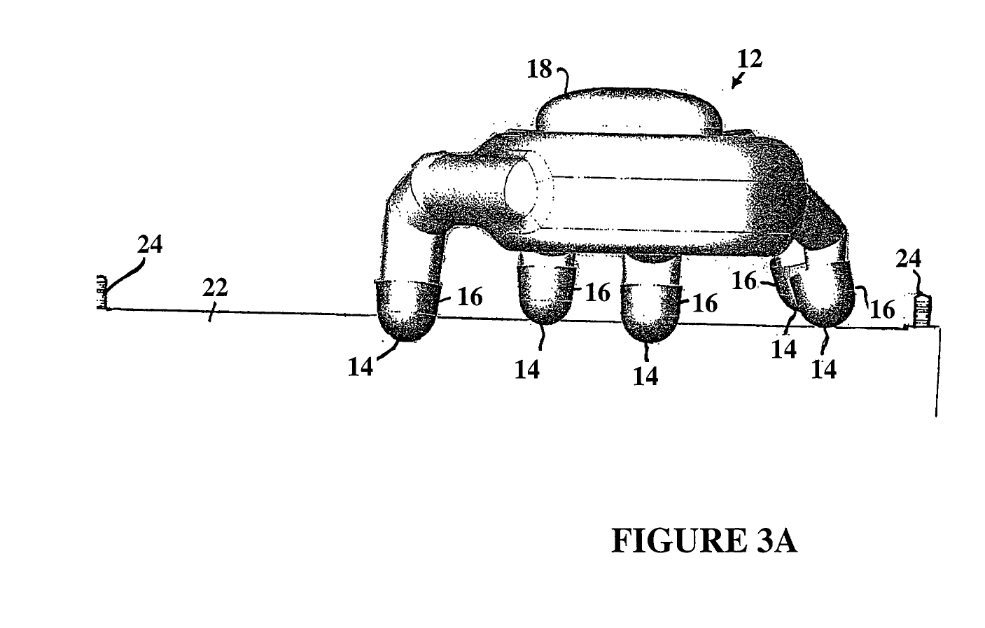

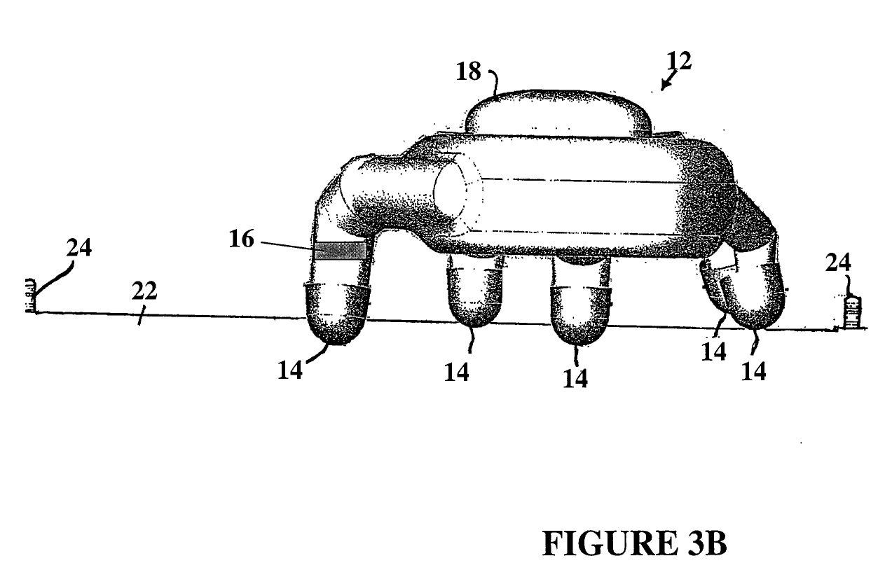

FIG. 3A is a back view of an exemplary digitizer glove 12. As described herein, the front of the digitizer glove is the side from which the fingers extend, the back of the digitizer glove is the side opposite the front, the bottom of the digitizer glove is the side analogous to the palm of a hand, and the top of the digitizer glove is the side opposite the bottom. As shown in FIG. 3A, a user inserts his/her hand into the digitizer glove 12 from the back. FIG. 3A does not show a securing means for securing the digitizer glove 12 to a user's hand. However, any appropriate securing means may be used, such as straps, adhesive, snaps, hook and pile fasteners (e.g., VELCRO®), and any combination thereof, for example.

FIG. 3B is a back view of an exemplary digitizer glove 12 comprising ultrasonic transducers 16 configured as rings. The ring shaped transducers 16 as shown in FIG. 3B functions similarly to the transducers 16 as described above. Only one ultrasonic ring transducer 16 is shown in FIG. 3B for purposes of clarity, but any number of rings may be included on the various fingers and/or thumb.

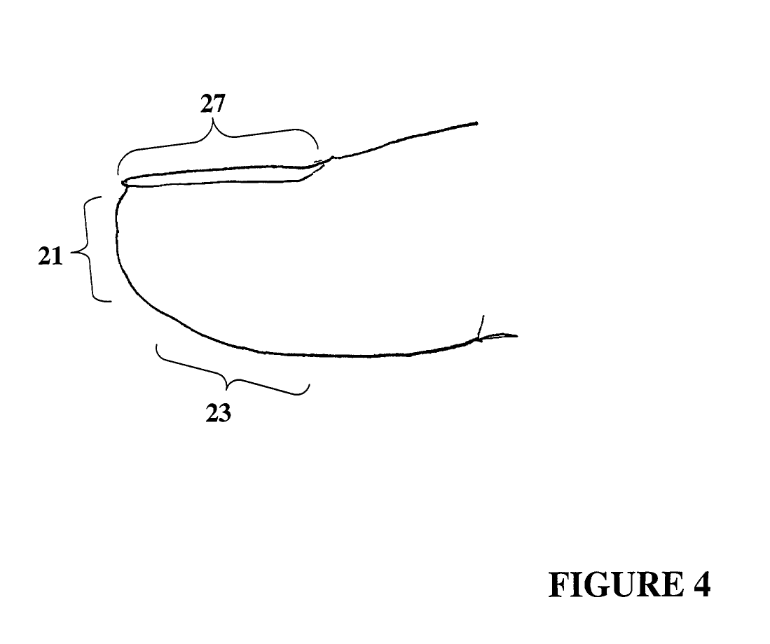

FIG. 4 is a side view of a fingertip with pertinent portions identified. In order to gain a better understanding of the examples described herein, the portion of a finger that makes contact with the character grid 22 is designated as the contact region 23. The contact region 23 is the portion of a finger that makes contact with a standard keyboard under normal typing conditions. The apex 21 of the finger, as shown in FIG. 3, is the portion of a finger between the contact region 23 and the nail bed. The nail bed 27 is the portion of a finger opposite the contact region 23. The nail bed, as used herein, is the surface portion of the finger where a fingernail normally resides. Thus, if a finger comprises a fingernail, the nail bed 27 includes the surface of the fingernail. A fingertip comprises a nail bed 27, an apex 21, and a contact region 23.

FIG. 5 is a top view of system 200 further showing display device 46. Display device 46 may comprise display devices such as a cathode ray tube (CRT), a flat panel display, a liquid crystal display, a plasma panel display, a light emitting diode (LED) display, or any appropriate display device. Character grid 22 is coupled to a host processor 106 (shown in FIG. 1) and display device 46 by connector 48. Digitizer glove 12 comprises a pressure sensitive switch 14 and an ultrasonic transducer 16 conformably positioned on the tip of each finger of the hand on which the glove 12 is mounted. The digitizer glove 12 comprises control device 18, wherein control device 18 comprises optical emitter 20. In this embodiment, the system 200 also comprises two ultrasonic receivers 24 and an optical detector 25. Ultrasonic transducers 24 and optical detector 25 are positioned in predetermined fixed locations with respect to each other and character grid 22. When any one of the pressure sensitive switches 14 of the digitizer glove 12 contacts the surface of character grid 22, the pressure sensitive switch 14, causes an electrical signal to be provided to control device 18. Pressure sensitive switch 14 may either close or open to cause the optical trigger signal and the ultrasonic signal to be transmitted. In response to this electrical signal, control device 18 causes optical emitter 20 to transmit an optical trigger signal, and causes an ultrasonic signal to be transmitted by the ultrasonic transducer 16 positioned on the same finger as the switch 14 that provides the electrical signal.

The optical detector 25 receives the optical trigger signal. A timer is then started and the ultrasonic receivers 24 are armed (in preparation for receiving the ultrasonic signal). Because light travels faster than sound, the optical trigger signal is received by the optical detector 25 before the ultrasonic signal is received by the two ultrasonic receivers 24. Using the received trigger signal as a start time, the time (propagation time) it takes for the ultrasonic signal to reach each of the ultrasonic receivers 24 is determined by processor 106. The location of the fingertip is determined in accordance with these propagation times. The position of a finger is indicative of the character 26 being selected. That is, the position of the fingertip is correlated (compared) to the predetermined locations of characters 26 on character grid 22 to determine which character, or characters are being selected by the user.

Control device 18 may comprise appropriate circuitry, a processor, or combination thereof for receiving trigger signals and accordingly controlling the transmission of ultrasonic and optical signals. As shown in FIGS. 2 and 5, control device 18 is hand mounted. However, other embodiments are envisioned, wherein control device 18 may be a stand alone unit, or may be incorporated as part of a host processor, such as a personal computer, mainframe computer, lap top computer, notebook computer, PDA, or any combination thereof, for example. Control device 18 is electrically coupled to the ultrasonic transducers 16, the switches 14, and the optical emitter 20. In embodiments wherein control device 18 comprises a processor, the processor comprises software or firmware for receiving trigger signals and accordingly controlling the transmission of ultrasonic and optical signals.

In another embodiment, system 200 comprises a mode control switch for switching from keyboard mode to pointer mode. This mode control switch may be incorporated into the digitizer glove 12, the character grid 22 (shown as character 47 in FIG. 5), or both. Toggling the mode control switch allows the digitizer glove 12 to alternately function as a mouse and a keyboard character selector. In the mouse mode, at least one ultrasonic transducer 16 transmits repetitive bursts of ultrasonic signals while the pressure sensitive switch 14 of the corresponding fingertip, the transmitting finger, is actuated (e.g., switch 14 either opened or closed as a result of being in contact with character grid 22). The transmitting finger position is translated into X-Y coordinates to achieve mouse functionality. That is, as the fingertip is maneuvered along the surface of the character grid 22, the position of the fingertip in the X-Y plane is tracked, wherein the X-Y plane is the plane of the surface of the character grid 22.

In yet another embodiment, mouse functionality is achieved without requiring a switch 14 to be in contact with the character grid 22. In this embodiment, once the mouse mode is selected via actuation of the mode control switch (e.g., selection of character 47), the digitizer glove remains in the mouse mode, and at least one ultrasonic transducer 16 transmits repetitive bursts of ultrasonic signals regardless of the transmitting finger being in contact with the character grid 22. In a preferred embodiment, the transmitting finger is the index finger of either the right or left hand (selectable) digitizer glove. Selection of either the right or left hand may be accomplished by an appropriate switching means, by software control, or a combination thereof.

Various embodiments of the mode control switch are envisioned. In one embodiment, the mode control switch is implemented as a character 47 (see FIG. 5) on character grid 22. Thus, the user can alternately switch between character mode and mouse mode by contacting the mode control character 47 with a fingertip of the digitizer glove 12. In another embodiment, at least one (i.e., the left hand or right hand) of the digitizer gloves 12 comprises a mode control switch. This digitizer glove mode control switch may comprise any appropriate switch known in the art coupled to the digitizer glove. This digitizer glove mode control switch may also comprise a piezoelectric film, which actuates a switch when a finger or fingers are bent, or when specified fingers are touched together (e.g., first finger and thumb).

As described above, optical emitter 20 provides an optical signal, which is utilized by the processor 106, along with ultrasonic signals, to determine the position of a finger on the digitizer glove 12. In an another embodiment, an optical signal is not utilized. Rather, an electrical signal is utilized instead of the optical signal. In this embodiment, character grid 22 comprises pressure sensitive material and/or circuitry to determine when a fingertip of glove 12 is in contact with character grid 22. This pressure sensitive material/circuitry may comprise a piezoelectric film, a variable resistance material; variable capacitance circuitry (e.g., capacitive touch switch), variable resistive circuitry (resistive touch switch); or a combination thereof, for example. When a fingertip of digitizer glove 12 contacts the pressure sensitive character grid 22, the pressure sensitive switch 14 and the pressure sensitive character grid 22 are actuated. The pressure sensitive switch 14, causes an electrical signal to be provided to control device 18. In response to this electrical signal, control device 18 causes an ultrasonic signal to be transmitted by the ultrasonic transducer 16 positioned on the same finger as the switch 14 that provided the electrical signal. Actuation of pressure sensitive character grid 22 starts a timer and arms the ultrasonic receivers 24 (in preparation for receiving the ultrasonic signals). The ultrasonic receivers 24 then receive the ultrasonic signals. Because an electrical signal travels faster than sound in air, the electrical trigger signal resulting from the actuation of pressure sensitive character grid 22 is received by the processor before the ultrasonic signal is received by the ultrasonic receivers 24. Using the received electrical trigger signal as a start time, the time (propagation time) it takes for the ultrasonic signal to reach each of the ultrasonic receivers 24 is determined. The location of the fingertip is determined in accordance with these propagation times. The position of the fingertip is correlated (compared) to the predetermined locations of characters 26 on character grid 22 to determine which character, or characters are being selected by the user.

In yet another embodiment, each ultrasonic transducer 16 transmits a unique ultrasonic signal, for example, a pattern of ultrasonic bursts, wherein the number of bursts is unique for each transducer 16. This allows each finger to be uniquely identified by the system 200. Identification of individual fingers provides the processor 106 with the capability to determine the position of a plurality of fingertips, simultaneously. Thus, allowing a user to select multiple characters 26 on character grid 22 at the same time. Furthermore, the ability to identify individual fingers is particularly applicable when the system 200 is in the pointer/mouse mode. Thus allowing the processor 106 to track multiple fingers simultaneously.

In another embodiment, character grid 22 comprises a pressure sensitive character grid as described above, and optical device 20 is an optical detector and optical device 25 is an optical emitter. Examples of optical emitters include LEDs and laser diodes, operating in the visible light spectrum, infrared spectrum or both. Examples of optical detectors include photodetectors, phototransistors, and photodiodes, operating in the visible light spectrum, infrared spectrum or both. In this embodiment, When a fingertip of digitizer glove 12 contact pressure sensitive character grid 22, the pressure sensitive switch 14 and the pressure sensitive character grid 22 are actuated. Mouse/pointer functionality is utilized to select characters on character grid 22. A mode control switch is actuated (mode control switch not shown) to configure glove like device 12 to the pointing mode. In the pointing mode, at least one actuated ultrasonic transducer 16 of the finger of glove like device 12 transmits repetitive bursts of ultrasonic signals whenever the pressure sensitive switch 14 of the corresponding fingertip is actuated (either opened or closed). The finger position is translated into X-Y coordinates to achieve pointer device functionality. In the pointer mode, the glove like device 12 may function like a mouse and/or a pointer, wherein relative position of the pointer is determined rather than the absolute position of the pointer. That is, as the fingertip is maneuvered along the surface of the character grid 22, for example, the position of the fingertip in the X-Y plane is tracked, wherein the X-Y plane is the plane of the surface of the character grid 22. In this embodiment, the need for an optical emitter and receiver is eliminated, thus reducing power requirements of the system 100 and increasing battery life.

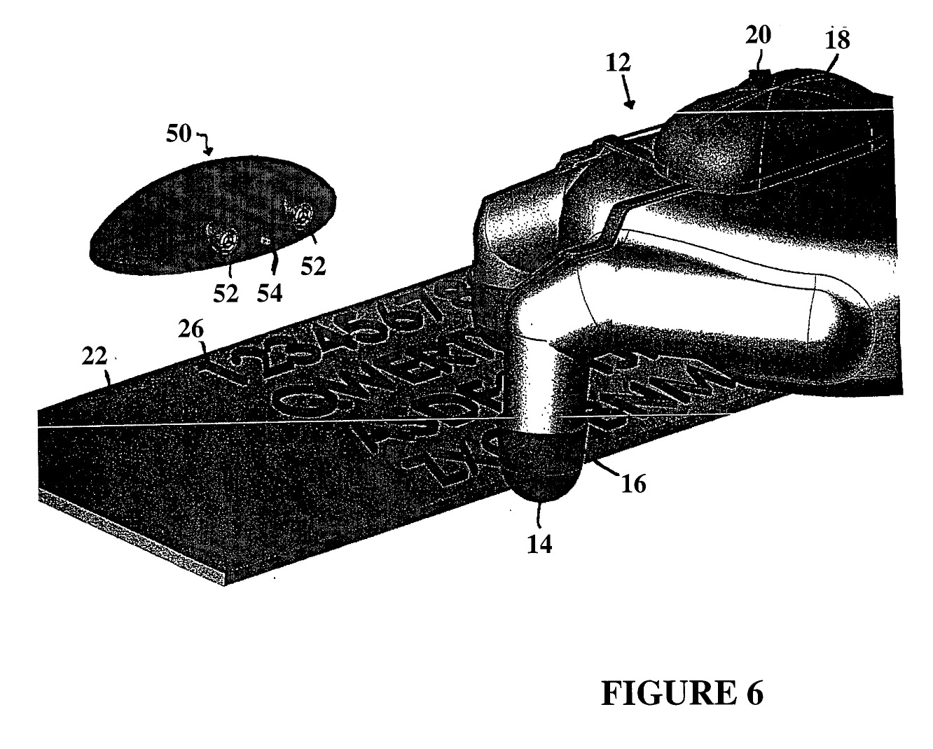

FIG. 6 is an illustration of another embodiment of the digitizer system comprising the receiving portion configured as a pod 50. Receiving pod 50 comprises ultrasonic transducers 52 and optical device 54. Pod 50 is electrically coupled to processor 106 (shown in FIG. 1). Alternative embodiments of pod 50 comprise more than two ultrasonic transducers 52, optical device 54 comprising an optical emitter, optical device 54 comprising an optical detector, and combinations thereof.

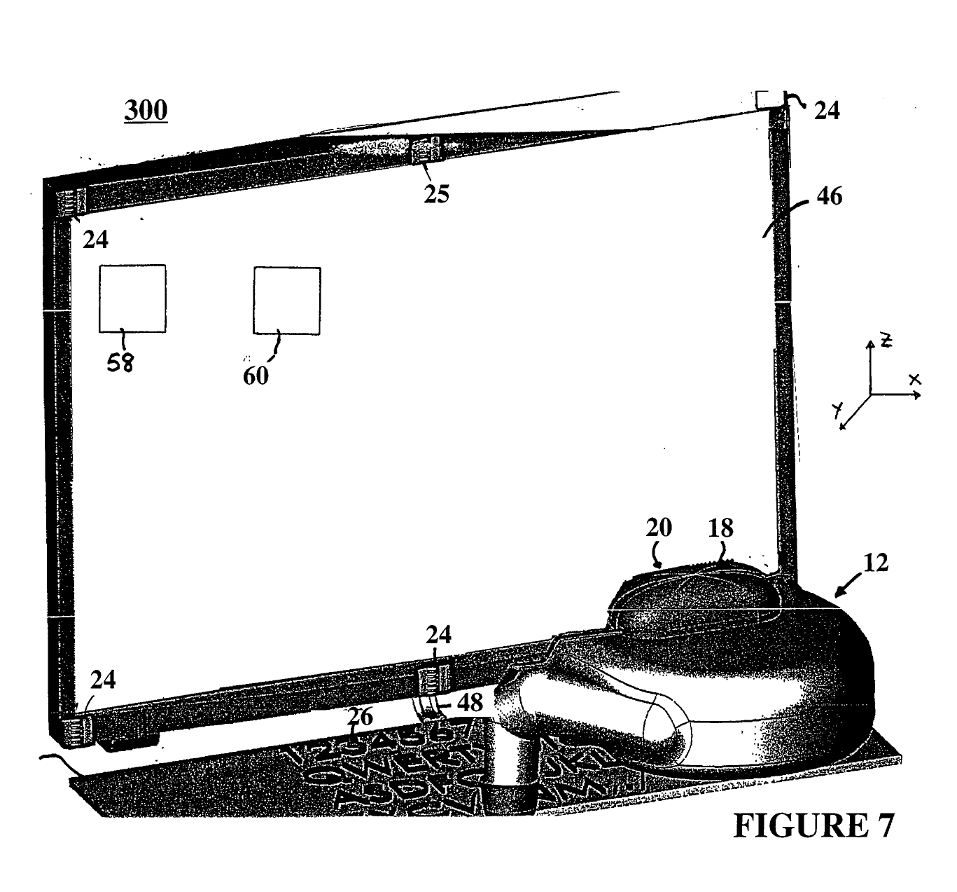

FIG. 7 is an illustration of an exemplary system 300 comprising the ultrasonic transducers 24 positioned in a plane differing from and not parallel to the plane of character grid 22. In this embodiment, device 20 is an optical detector (e.g., photodiode, photodetector, phototransistor). The ultrasonic transducers 24 comprise a minimum of three ultrasonic transducers and optical device 25 comprises an optical emitter (e.g., an LED or laser diode, operational in the visible spectrum, infrared, or both). As system 300 is depicted in FIG. 7, ultrasonic transducers 24 and optical emitter 25 are positioned in front of digitizer glove 12, on the display device 46, however the specific locations of optical emitter 25 and ultrasonic transducers 24 are exemplary. In operation, the optical emitter 25 repeatedly transmits an optical signal at predetermined intervals. A timer is started at the commencement of the transmission of each optical signal. In an exemplary embodiment, the timer is implemented as a software timer by processor 106 (shown in FIG. 1). When the optical signal is received by the optical detector 20, control device 18 causes an ultrasonic signal to be transmitted by each of ultrasonic transducers 16. In this embodiment, each ultrasonic transducer 16 transmits a unique ultrasonic signal (e.g., a pattern of ultrasonic bursts, wherein the number of bursts is unique for each transducer 16). The ultrasonic receivers 24 then receive the ultrasonic signals. Using the timer as a reference, the time it takes for the ultrasonic signal to reach each of the ultrasonic receivers (propagation time) is determined. The three dimensional location of each fingertip is determined in accordance with these propagation times. One advantage of system 300 is that simultaneous multiple keystrokes (e.g., selecting more than one character 26 simultaneously), may be detected, because each fingertip's position is constantly defined in three-dimensional space.

The position on the z axis (the z axis is the axis orthogonal to the plane of the character grid 22; see axis in FIG. 7) of each fingertip is used to determine if any fingertips are in the “key striking” region, based on the x,y plane describing the character grid 22. The key striking region comprises a predetermined distance from the character grid 22, in the z direction. A fingertip positioned within the key striking region is considered to be close enough to the character grid 22 to select a character 26. The X and Y positions of each fingertip in a key striking region are compared to the predetermined locations of the grid characters 26 to determine which character 26 is being selected by the user.

System 300 provides the functionality of a mouse, a pointer digitizer, and a touch screen. As described above, a mode control switch (not shown) is actuated to configure digitizer glove 12 to the mouse/pointer mode. In the mouse/pointer mode, at least one actuated ultrasonic transducer 16 of a finger of digitizer glove 12 transmits repetitive bursts of ultrasonic signals whenever the pressure sensitive switch 14 of the corresponding fingertip is actuated. The finger position is translated into X-Y coordinates to achieve mouse functionality. That is, as a fingertip is maneuvered along the surface of the character grid 22, the position of the fingertip in the X-Y plane is tracked, wherein the X-Y plane is the plane of the surface of the character grid 22.

Furthermore, touch screen functionality is achieved by this embodiment. Touch screen functionality comprises the selection of a display pattern on display device 46 by a selecting finger. A finger selects a pattern displayed on display device 46 by touching the pattern. The position of the selecting finger is determined in accordance with the ultrasonic positioning techniques described herein. The three-dimensional tracking capability of this embodiment allows the digitizer glove 12 and the display device 46 to function as a touch screen. For example, either of display areas 58 or 60 may be selected by positioning a fingertip proximate to the desired area, 58 or 60. The position on the X axis (the X axis is the axis orthogonal to the plane of the display device 46; see axis in FIG. 7) of each fingertip is used to determine if any fingertips are in the “key striking” region, proximate to the Y,Z plane describing the display device 46. Thus, the key striking region comprises a predetermined distance from the display device 46, in the X direction. A fingertip positioned within the key striking region is considered to be close enough to the display device 46 to be pointing at coordinates on the surface of the display device 46. Accordingly, the Y and Z positions of each fingertip in a key striking region are tracked.

System 300 does not require an optical emitter 20. Accordingly, the power requirements of the digitizer glove 12 are reduced as compared to a digitizer glove 12 utilizing an optical emitter 20. One advantage of a reduced power requirement is the resulting increase in battery life. In another attempt to increase battery life, and reduce power requirements, it is envisioned that a piezoelectric film on the digitizer glove may provide a charge to a rechargeable battery whenever a finger is bent.

In yet another embodiment, control keys (e.g., shift, alt, ctrl) are controlled by software to be in either the “on” state or the “off” state. This helps to avoid the situation wherein two ultrasonic signals arrive at the receivers at the same time.

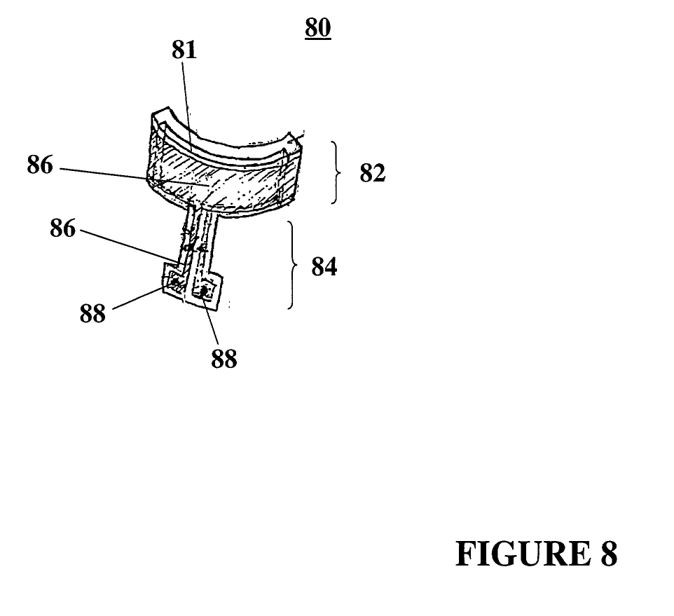

Various embodiments of the fingertip mounted ultrasonic transducer are envisioned. FIG. 8 is an illustration of another embodiment of an ultrasonic transducer 80. Ultrasonic transducer 80 comprises an upper portion 82 coupled to a lower member 84. Piezoelectric film 86 is a film having piezoelectric properties. An example of a piezoelectric film having piezoelectric properties is a film comprising Polyvinylidene Fluoride (PVDF film). Upper portion 82 comprises an air gap 81, allowing the piezoelectric film 86 to vibrate. Member 84 also comprises piezoelectric film 86. Electrodes 88 provide a coupling means for coupling the piezoelectric film 86 to electrical circuitry. The piezoelectric film 86 is coupled to the upper portion 82 and the lower member 84. The piezoelectric film 86 and the upper portion 82 are curved to approximately conform to the shape of a finger.

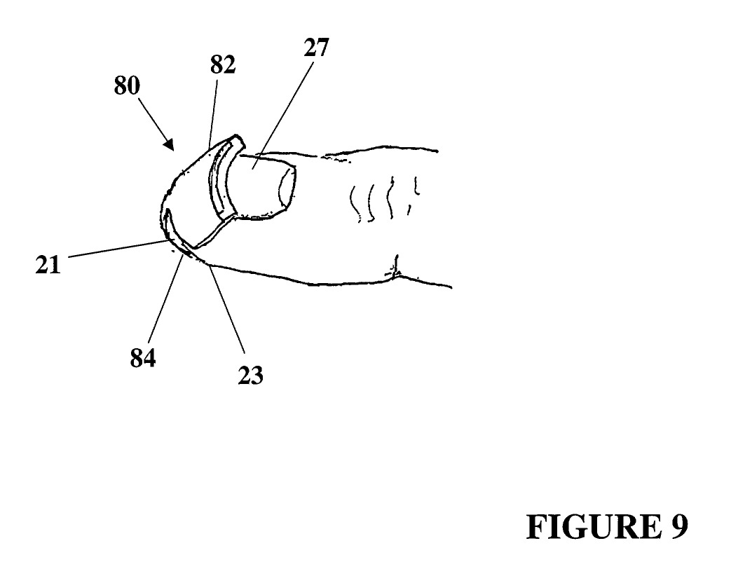

FIG. 9 is an illustration of an ultrasonic transducer 80 mounted on a fingertip. The ultrasonic transducer 80 is positioned on the fingertip and is conformably shaped to the fingertip. Accordingly, upper portion 82 is curved to conform to the shape of a finger, and lower member 84 is curved to conform to the apex 21 and contact region 32 of the finger. The upper portion 82 of the ultrasonic transducer 80 is positioned above the apex 21 of the fingertip and adjacent to the nail bed 27 of the fingertip. The lower member 84 of ultrasonic transducer 80 is conformably positioned on the apex 21 and contact region 23 of the fingertip.

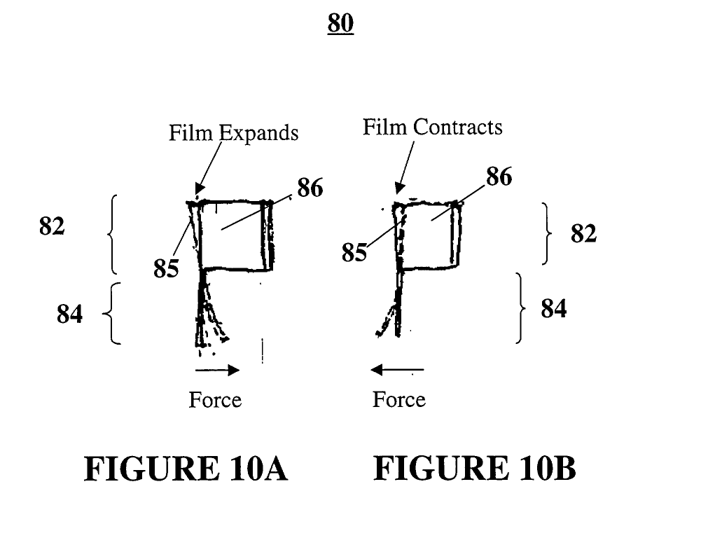

When member 84 is displaced or deformed, a corresponding voltage is created. This voltage is available at electrodes 88. FIG. 10 is an illustration of two side views of an ultrasonic transducer 80 depicting displacement of the ultrasonic transducer 80. When lower member 84 is displaced normal to its surface (in the direction of the force arrows shown in FIGS. 10A and 10B), the curved portion 85 of the piezoelectric film is accordingly strained, i.e., expanded by tension (FIG. 10A) or contracted by compression (FIG. 10B). The curved portion 85 of the piezoelectric film 86 is the portion of the film 86 mounted to the upper portion 82 of transducer 80. A voltage is generated in response to this displacement and strain. The generated voltage has an opposite polarity in the case of an expansion of the piezoelectric film in tension 86 than for a contraction of the piezoelectric film 86 in compression.

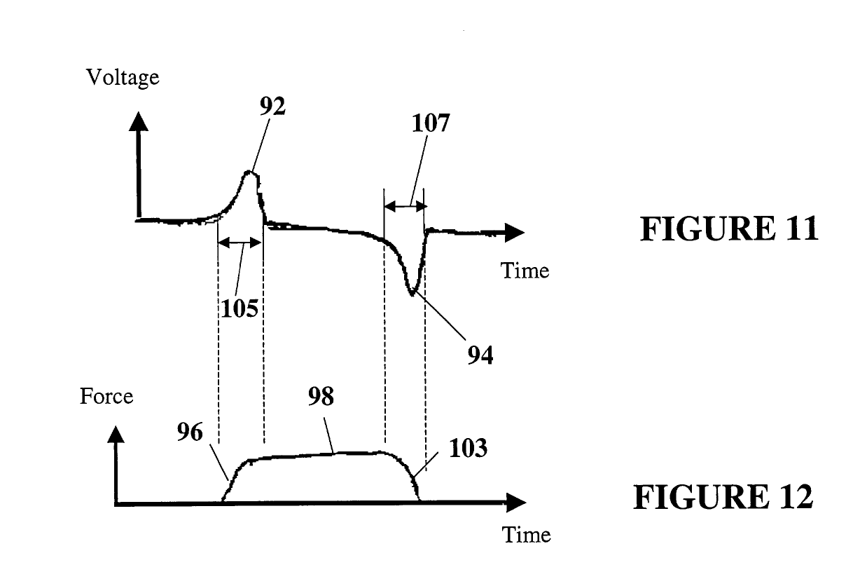

Referring again to FIG. 9, when the fingertip pushes on a surface, such as character grid 22, member 84 is displaced, causing piezoelectric film 86 in upper portion 82 to expand, resulting in a voltage being generated and available at electrodes 88. FIG. 11 is a graph of an exemplary voltage waveform resulting from the exemplary force exerted on transducer 80 plotted in FIG. 12. An exemplary force applied to transducer 80 mounted on a fingertip is shown in FIG. 12. This type of force may, for example, result from a user striking a character 26 on character grid 26 with the contact region 23 of the user's fingertip. As a function of time, the pushing force increases (96), remains approximately constant (98), and then decreases (103). Correspondingly, as shown in FIG. 11, a positive voltage 92 is generated as a result of the increasing force 96. The generated voltage is approximately equal to zero as a result of the approximately constant force 98, and a negative voltage 94 is generated in response to the decreasing force 103. The pulse width of each of pulses 92 and 94 may be a few milliseconds. For example, the maximum pulse width of pulse 92 (pulse width 105) and the maximum pulse width of pulse 94 (pulse width 107) may be approximately 3 milliseconds. As explained in detail herein, the generated voltages (e.g., pulse 92 and 94), are used as trigger signals to commence the transmission of ultrasonic signals.

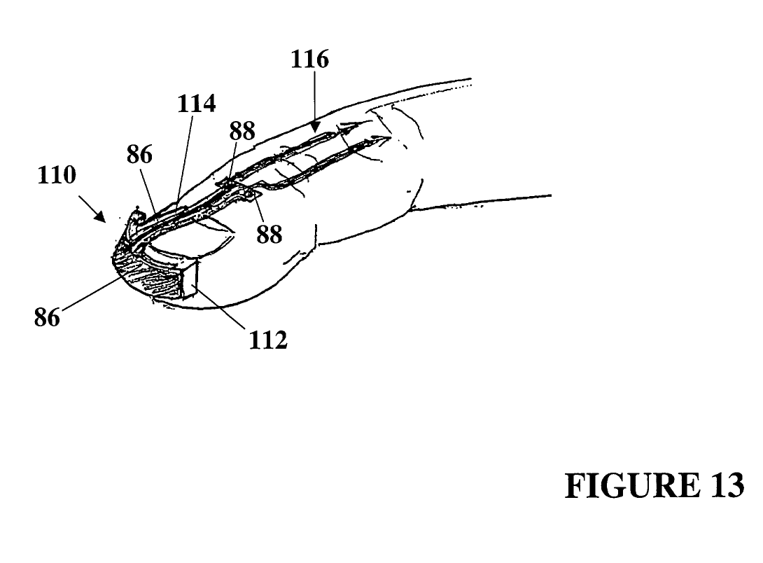

FIG. 13 is an illustration of another embodiment of an ultrasonic transducer 110, positioned on a finger. Ultrasonic transducer 110 comprises an upper member 114 and a lower portion 112. As shown in FIG. 13, lower portion 112 is conformably positioned on the apex 21 of a fingertip. Accordingly, the portion of piezoelectric film 86 in lower portion 112 is curved to conform to the apex 21 of the fingertip. The upper member 114 is conformably positioned above the apex 21 of the fingertip and adjacent the nail bed 27 of the fingertip. Electrodes 88 are electrically coupled to electrical conductors 116. When the finger is bent, such as to select a character 26 on character grid 22, the upper member 114 of ultrasonic transducer 110 is displaced, thus causing a voltage to be generated. Ultrasonic transducer 110 functions similarly to ultrasonic transducer 80. The relationships between the displacement and strain of piezoelectric film 86, and the resulting voltages pertaining to ultrasonic transducer 110, are the same as described above with respect to ultrasonic transducer 80.

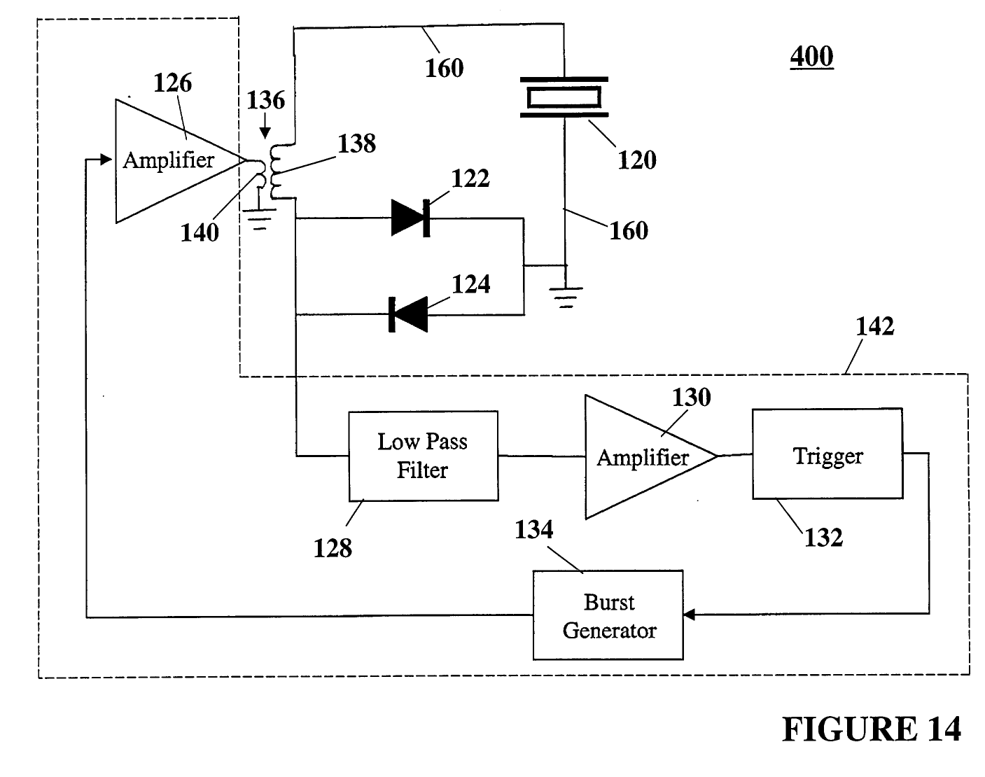

The piezoelectric film 86 is utilized to both sense the force resulting on the film 86 as a result of finger tip impact, and to transmit ultrasonic signals. Both of these functions are accomplished via common electrodes (e.g., electrodes 88). Thus, circuitry comprising means for receiving the sensed signal (sense signal) and transmitting the signal (drive signal) for ultrasonic transmission is coupled to the piezoelectric film 86. FIG. 14 is a circuit diagram of exemplary transmit/receive (T/R) circuitry 400. When a force is exerted on the piezoelectric film 86 of the ultrasonic transducer, the film 86 generates a voltage, which may be on the order of several hundred millivolts. For example, this voltage may range from 100 millivolts to 900 millivolts. However, the voltage used to cause the piezoelectric film to transmit an ultrasonic signal may be in the range of 50 volts to 500 volts.

The T/R circuit 400 protects the sensor input circuitry 142 from being damaged by the high voltage transmission signal (drive signal), and prevents the sense signal from being swamped by the high voltage drive circuit. Piezoelectric film 86 has a capacitance. Accordingly, variable capacitor 120 represents the piezoelectric film 86. The generated voltage is coupled to the transmit/receive circuit through the secondary winding 138 of transformer 136. The inductance of the secondary winging 138 and the capacitance of the piezoelectric film 120 comprise a resonant frequency, which is the frequency of the ultrasonic signal (drive frequency). An exemplary range of drive frequencies is between 10 kHz and 40 kHz, inclusively. The frequency of the sensing current is typically less than the drive frequency. An exemplary range of sensing signal frequencies comprises 0 Hz to 500 Hz. Thus, the sensing current is only slightly attenuated by the secondary winding 138, allowing the sensing current to be conducted through the winding 138 to the sensing input circuitry 142. The two parallel diodes (122, 124) are coupled in series between the secondary winding 138 of the transformer 136 and ground. The impedance presented by the diodes 122, 124 is typically very small (practically negligible) when the voltage across the diodes is greater than 1 volt. Therefore, the voltage at the input to the input sensing circuitry 142 is approximately 1 volt or less during the drive period (time when ultrasonic signal is being transmitted), and thus the input sensing circuitry 142 is protected from the high voltage generated by the resonant circuit comprising capacitor 120 and the secondary winding 138.

When the voltage across the diodes 122, 124 is less than approximately 1 volt (as is the case of the sensing voltage), the impedance presented by the diodes is high. Thus the sensing voltage is not shunted to ground by the diodes 122, 124, but is provided to the input sensing circuitry 142. The sensing signal is filtered to remove unwanted higher frequency components (such as the drive frequency) by low pass filter 128. The filtered signal is amplified by amplifier 130. Once the amplified signal reaches a predetermined threshold value, the trigger circuitry 132, starts burst generator 134. The burst generator 134 generates a few cycles of the drive signal, which is provided to the primary winding 140 of transformer 136 through drive power amplifier 126.

The drive signal voltage is increased by step up transformer 140. The inductance of the secondary winding 138 resonates with capacitance of piezoelectric film (represented by capacitor 120). During the drive period, a high current circulates through the secondary winging 138, the variable capacitor 120, and the two diodes 122, 124, the diode impedance becomes very low, and the diodes 122, 124 do not damp the resonance.

The T/R circuit 400 may be a hand mounted device, a circuit incorporated in processor 106, apart of a separate unit, such as pod 50, or a combination thereof. The T/R circuit of FIG. 14 is coupled to the piezoelectric film 86. In a preferred embodiment, the T/R circuit 400 is hand mounted as part of control device 18.

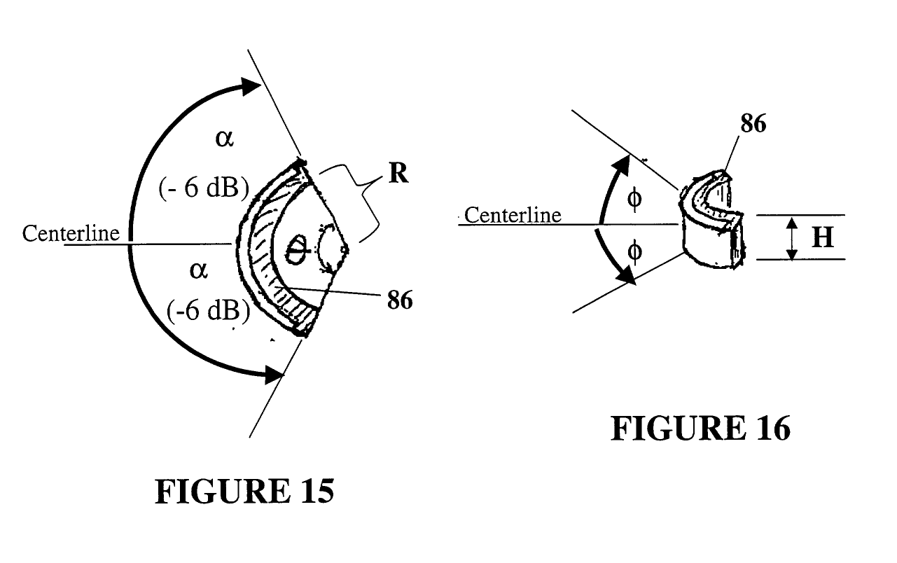

FIGS. 15 and 16 are a top view and an elevated view, respectively, to of a curved piezoelectric film 86. In an exemplary embodiment, the resonance frequency is approximately 200/R (Hz) where R is the curvature radius, of the piezoelectric film in meters. For example, R=5 mm results in a resonant frequency equal to approximately 40 kHz and R=2 cm, results in a resonant frequency equal to approximately 10 kHz. To produce an ultrasonic signal at the resonant frequency, the T/R circuit of FIG. 14, for example, provides a range of one to a few (e.g., 3) cycles of the burst signal at the resonance frequency to electrodes (e.g., electrodes 88) coupled to the curved piezoelectric film 86 and the vibration of the film 86 generates an acoustic wave at the resonant frequency. Without further stimulation, this amplitude of the acoustic waves decays over several cycles. For example, the amplitude may decay to approximately 5% of the original amplitude within five cycles of the wave.

Finger mounted ultrasonic transducers as described herein transmit (or receive) ultrasonic waves from the fingertips of one, or two, hands, to receiving transducers. Thus, ultrasonic acoustic energy propagates between and around the fingers. Typical separations between finger mounted transducers may range from up to approximately 5 cm for directly adjacent fingers, and up to approximately 15 cm between the thumb and fifth finger (e.g., pinky). The Propagation Direction of the finger mounted ultrasonic transducers need not be omnidirectional, however, the propagation angle (i.e., the beam width of the propagated ultrasonic wave) should be wide enough to ensure transmission of the ultrasonic signal from each fingertip to the receiving transducers. It has been determined that a propagation angle α (beam width measured at 6 dB points) of, for example, ±60 degrees from the centerline of the curved piezoelectric film in the horizontal plane, as shown in FIG. 15, is adequate. To achieve α=±60 degrees, θ should be equal to or greater than 140 degrees. Also, the acoustic pressure of the transmitted ultrasonic signal at ±60 degrees from the centerline should be no less than 6 dB down from the acoustic pressure of the transmitted ultrasonic signal at the centerline.

The transmitted ultrasonic signal should also propagate in a vertical direction (plane orthogonal to horizontal plane) because the orientation of the finger mounted transducer may vary from being parallel to the character grid 22 to being perpendicular to the character grid 22. It has been determined that a propagation angle, φ, of at least ±45 degrees (beam width measured at 6 dB points) from the centerline of the curved piezoelectric film in the vertical plane, as shown in FIG. 16, is adequate. Also, the acoustic pressure of the transmitted ultrasonic signal at φ±45 degrees from the centerline should be no less than 6 dB down from the acoustic pressure of the transmitted ultrasonic signal at the centerline.

As shown in FIG. 16, H is the vertical dimension (height) of the curved portion of piezoelectric film 86. To achieve φ>±45 degrees in the transmission frequency range of 10 kHz to 30 kHz, and meet the above vertical and horizontal plane propagation angle and power values, it has been determined that a range of H equal to or less than approximately 3 cm, is adequate. Generally, as the value of H decreases for a given value of φ, the frequency increases. Also, as the value of H decreases, the vertical propagation angle, φ, becomes wider. For example, a piezoelectric film having H=3 cm and φ=±45 degrees, results in a transmission frequency being approximately equal to 10 kHz, a piezoelectric film having H=1.5 cm and φ=±45 degrees, results in a transmission frequency being approximately equal to 20 kHz, and a piezoelectric film having H=1.0 cm and φ±45 degrees, results in a transmission frequency being approximately equal to 30 kHz. It is also observed that as H becomes smaller, the vertical propagation angle (i.e., the beam width) becomes wider. As explained herein, the hand mounted ultrasonic transducer may function as transmitters or receivers, depending on the embodiment. The above performance parameters pertaining to the angles φ and θ apply regardless to whether the hand mounted transducers function as transmitters or receivers.

Typically a keyboard is used not by a single finger, but by multiple fingers. Thus, it is possible that as one finger selects a character 26 on the character grid 22, another finger may be in the propagation path of the transmitted ultrasonic signal to the receiving transducer. In this case, the amplitude of the received acoustic pressure of the transmitted ultrasonic signal may be reduced by this blocking effect. It has been observed that this signal loss is related to the transmission frequency. That is the loss is greater at higher frequencies. For example, the received acoustic pressure (subject to blocking) is 80% of the transmitted acoustic pressure (not subject to blocking) for a transmission frequency of 15 kHz, the received acoustic pressure is 55% of the transmitted acoustic pressure for a transmission frequency of 25 kHz, and the received acoustic pressure is only 17% of the transmitted acoustic pressure for a transmission frequency of 80 kHz. As the “blocking object” becomes small compared to the wavelength of the propagating wave, or as the wavelength becomes large as compared to the blocking object, the contribution of the blocking object to signal loss becomes less. As frequency decreases, the wavelength increases. Thus, the loss due to a finger blocking the propagation path of a lower frequency ultrasonic signal is less than for a higher frequency ultrasonic signal. Since this loss is less for lower frequencies, it may be advantageous to transmit lower frequencies, such as the range of approximately 10 kHz to 25 kHz, for example.

Also, a blocking object, such as a finger, effects the propagation time of the transmitted signal from transmitter to receiver. It has been observed that an approximately 6 μsec increase in propagation time for a 15 cm propagation distance, when a single finger was placed in the propagation path. This increase in time corresponds to an approximate 1.7 mm shift in finger position.

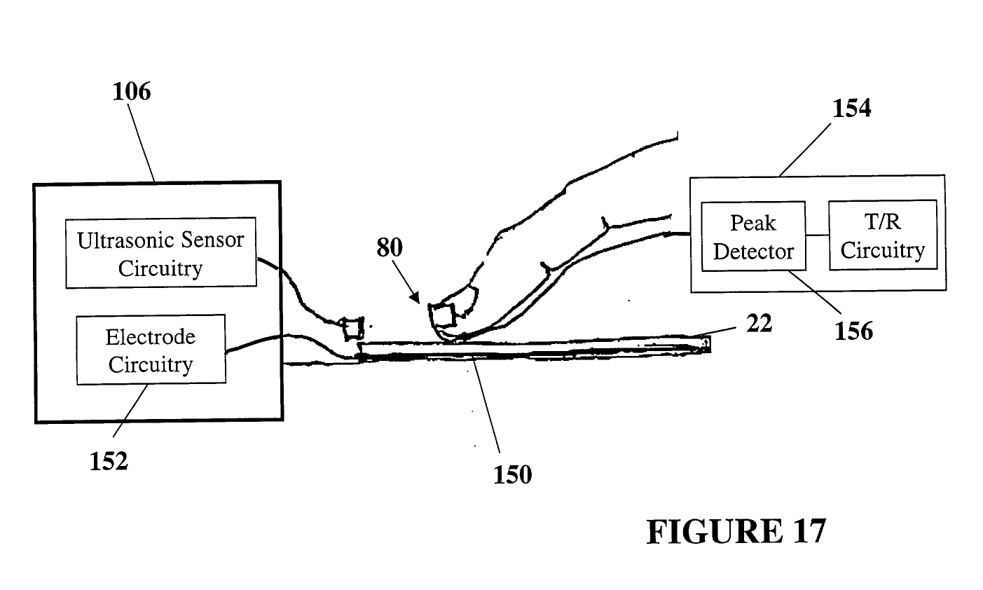

FIG. 17 is an illustration of another embodiment illustrating a character grid 22 comprising an electrode for sensing contact. As described above with respect to FIGS. 11 and 12, the sensing signal may be provided by the impact of the fingertip mounted transducer against a surface. However, the amplitude of the sensing signal is a function of the force and variation in time of the impact. For example, referring again to FIG. 11, the greater the force of the impact, the greater the amplitude of the sensing signal pulse 92. If the force of the impact is slowly applied, and slowly released, the value of the amplitude of the generated signal is small. A constant value of applied pressure generates no signal. FIG. 17 shows another embodiment, wherein steady touching of the character grid 22 is detectable. Character grid 22 comprises an electrode 150 positioned adjacent the bottom surface of character grid 22. An electrical signal is applied to electrode 150 by oscillator circuit 152. Oscillator circuit 152 may comprise any appropriate means for providing an oscillator signal to the electrode 150. An example of an oscillator signal is a 10-volt rms AC voltage at 400 Hz. When a finger touches the character grid 22, capacitive coupling between the electrode 150 and the finger results in sensing signal of a few millivolts (e.g., 1 mV to 100 mV) being provided to the T/R circuit 154. The capacitvely coupled sensing signal is detected by T/R circuit 154, and utilized as a trigger signal. T/R circuit 154 comprises a peak detector circuit 156 for detecting the amplitude of the capacitively coupled sense signal. When the peak detector circuit 156 determines that the amplitude of the capacitively coupled sense signal exceeds a predetermined threshold value, the peak detector 156 actuates the T/R circuit as described above with reference to FIG. 14. Thus, a finger may remain in contact with the character grid 22, wherein slight variations of the force applied to the character grid 22 are detectable.

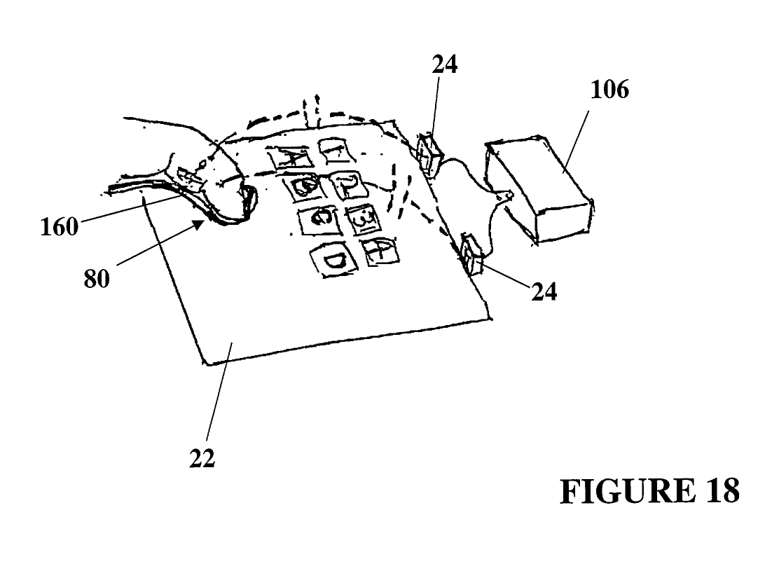

FIG. 18 is an illustration of another embodiment, wherein the sensing signal is capacitively coupled to the receiving transducers through air. As described above with respect to various exemplary embodiments, an optical signal is utilized as a sense and trigger signal. The embodiment shown in FIG. 18 utilizes capacitive coupling between the electrical conductors carrying the drive signal to the piezoelectric film 86 and the receiving transducers 24 to provide the sense signal. Referring to FIGS. 14 and 18, the electrical conductors 160 coupled between the secondary winding 138 of transformer 136 and piezoelectric film 86 (denoted as capacitor 120 in circuit 400) carry a high voltage drive signal. The current flowing through these electrical conductors 160 generates an electric field in air. These electric fields are detected by the receiver transducers 24. The piezoelectric film in the receiver transducers 24 (e.g., PVDF film) has a high enough impedance that these electric fields are detectable. The capacitively coupled electric field is utilized as a sense signal, which propagates at approximately the speed of light, and thus is sensed by the receiving transducers 24 before the ultrasonic signals. The sense signals are subsequently used to trigger a T/R circuit.

Advantages of the various exemplary ultrasonic position determining systems include the fabrication and design of a keyboard that can be made ultra thin, easily portable, and flexible; providing the functionally of a mouse or other pointing device without the need for a separate mouse; and providing touch screen functionality without the need for a complex touch screen display device.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A device for indicating a position of a finger, said device comprising:
a piezoelectric film that provides a signal in accordance with a displacement of said film, said signal being indicative of a position of said finger, wherein said device is conformably shaped to fit on at least a portion of said finger.

2. A device in accordance with claim 1, wherein said device is conformably shaped to fit over a tip of said finger.

3. A device in accordance with claim 1, wherein said piezoelectric film comprises Polyvinylidene Fluoride (PVDF).

4. A device in accordance with claim 1, wherein:
said device comprises an ultrasonic transducer; and
said signal comprises an ultrasonic signal.

5. A device in accordance with claim 1, wherein said device comprises:
an upper portion shaped to be positioned above an apex of said finger and adjacent a nail bed of said finger; and
a lower member coupled to said upper portion, said lower member shaped to be conformably positioned on a contact region of a tip of said finger, wherein said signal is responsive to a displacement of said lower member.

6. A device in accordance with claim 1, wherein said device comprises:
a lower portion shaped to be conformably positioned on an apex of said finger; and
an upper member coupled to said lower member, said upper member shaped to be conformably positioned above said apex and adjacent a nail bed of said finger, wherein said signal is responsive to a displacement of said upper member.

7. A device in accordance with claim 1, said signal comprising a trigger signal and a transmission signal, wherein said trigger signal is responsive to a displacement of said film and said transmission signal is responsive to said trigger signal.

8. A device in accordance with claim 1, further comprising:
a switch for providing a trigger signal, wherein said switch is shaped to be conformably positioned on a contact region of a tip of said finger; and
a ring coupled to said switch, said ring comprising a piezoelectric film that provides a position signal indicative of a position of said finger, wherein:
said ring is shaped to be conformably positioned on said finger; and
said position signal is responsive to said trigger signal.

9. A device in accordance with claim 8, wherein said switch is one of the group consisting of a pressure sensitive switch and a proximity switch.

10. An apparatus for indicating the position of at least one finger of a hand on which said apparatus is adapted to be mounted, said apparatus comprising at least one transducer for providing at least one position signal indicative of a position of at least one respective finger, each transducer shaped to be positioned on a respective finger.

11. An apparatus in accordance with claim 10, wherein each transducer comprises piezoelectric film and said position signal is responsive to a displacement of said piezoelectric film.

12. An apparatus in accordance with claim 11, said position signal comprising a trigger signal and a transmission signal, wherein said trigger signal is responsive to a displacement of said film and said transmission signal is responsive to said trigger signal.

13. An apparatus in accordance with claim 10, wherein each transducer comprises Polyvinylidene Fluoride film and said position signal is responsive to a displacement of said Polyvinylidene Fluoride film.

14. An apparatus in accordance with claim 10, wherein:
each transducer is an ultrasonic transducer; and
each position signal comprises a respective ultrasonic signal.

15. An apparatus in accordance with claim 10, further comprising:
a control device for controlling a transmission of each position signal, said control device being mounted to said hand, each transducer being coupled to said control device; and
an optical emitter that provides a respective optical signal indicative of a position of each of said at least one finger, said optical emitter being coupled to said control device, wherein said control device controls a transmission of said optical signal.

16. An apparatus in accordance with claim 10, wherein each transducer is shaped to be conformably positioned on a respective finger, each transducer comprising:
an upper portion shaped to be positioned above an apex of said respective finger and adjacent a nail bed of said respective finger; and
a lower member coupled to said upper portion, said lower member shaped to be conformably positioned on a contact region of a tip of said respective finger, wherein said signal is responsive to a displacement of said lower member.

17. An apparatus in accordance with claim 10, wherein each transducer is shaped to be conformably positioned on a respective finger, each transducer comprising:
a lower portion shaped to be conformably positioned on an apex of a respective finger; and
an upper member coupled to said lower member, said upper member shaped to be conformable positioned above said apex and adjacent a nail bed of said respective finger, wherein said signal is responsive to a displacement of said upper member.

18. An apparatus in accordance with claim 10, wherein each transducer is shaped to be conformably positioned on a respective finger, each transducer comprising:
a switch for providing a trigger signal, wherein said switch is shaped to be conformably positioned on a contact region of a tip of a respective finger; and
a ring coupled to said switch, said ring comprising a piezoelectric film for providing a position signal indicative of a position of said respective finger, wherein:
said ring is shaped to be conformably positioned on said respective finger; and
said position signal is responsive to said trigger signal.

19. A system for determining a position of at least one finger, said system comprising:
a transmitting portion for transmitting a respective ultrasonic signal indicative of a position of each of said at least one finger of a hand on which said transmitting portion is adapted to be mounted, wherein an ultrasonic transducer for providing said respective ultrasonic signal is shaped to be conformably positioned on each of said at least one finger;
a receiving portion for receiving said transmitted ultrasonic signals; and
a processor for determining a position of each of said at least one finger in accordance with said received ultrasonic signals.

20. A system in accordance with claim 19, said transducer comprising a piezoelectric film for providing a trigger signal and said ultrasonic signal, wherein said trigger signal is responsive to a displacement of said piezoelectric film and said ultrasonic signal is responsive to said trigger signal.

21. A system in accordance with claim 19, further comprising a character grid comprising at least one character, wherein a position of each finger is indicative of a selection of one of said at least one character.

22. A system in accordance with claim 21, wherein said receiving portion is fixedly attached to said character grid.

23. A system in accordance with claim 21, said character grid further comprising circuitry for sensing a selection of a character, wherein:
an electrical signal is provided in response to said sensing a selection of a character; and
said processor determines a position of each of said at least one finger in accordance with said ultrasonic and electrical signals.

24. A system in accordance with claim 21, wherein:
said transmitting portion provides an electromagnetic signal responsive to a selection of a character; and
said processor determines a position of each of said at least one finger in accordance with said ultrasonic and electromagnetic signals.

25. A system in accordance with claim 19, wherein each ultrasonic transducer comprises a film comprising at least one of the group consisting of a piezoelectric material and a Polyvinylidene Fluoride.

26. A system in accordance with claim 19, wherein each transducer comprises:
an upper portion shaped to be positioned above an apex of a finger on which each respective transducer is positioned and adjacent a nail bed of that respective finger; and
a lower member coupled to said upper portion, said lower member shaped to be conformably positioned on a contact region of a tip of said respective finger on which each transducer is positioned, wherein said signal is responsive to a displacement of said lower member.

27. A system in accordance with claim 19, wherein each transducer comprises:
a lower portion shaped to be conformably positioned on an apex of a respective finger on which each transducer is positioned; and
an upper member coupled to said lower member, said upper member shaped to be conformably positioned above said apex and adjacent a nail bed of said respective finger on which each transducer is positioned, wherein said signal is responsive to a displacement of said upper member.

28. A system in accordance with claim 19, wherein each transducer comprises:
a switch for providing a trigger signal, wherein said switch is shaped to be conformably positioned on a contact region of a tip of a respective finger on which each transducer is positioned; and
a ring coupled to said switch, said ring comprising a piezoelectric film for providing said respective ultrasonic signal indicative of a position of said respective finger on which each transducer is shaped to be positioned, wherein:
said ring is shaped to be conformably positioned on said respective finger on which each transducer is shaped to be positioned; and
said respective ultrasonic signal is responsive to said trigger signal.

29. A system in accordance with claim 19, said transmitter portion further comprising an optical emitter for providing a respective optical signal indicative of a position of each of said at least one finger, wherein said processor determines a position of each of said at least one finger in accordance with said ultrasonic and optical signals.
